(19) United States
(12) Patent Application Publication
(10) Pub. No.: US 2013/0080247 A1
(43) Pub. Date: Mar. 28, 2013

(54) Ad Placement

(71) Applicants: Mehul Parsana, Bangalore (IN); Krishna Leela Poola, Bangalore (IN); Rahul Agrawal, Bangalore (IN)

(72) Inventors: Mehul Parsana, Bangalore (IN); Krishna Leela Poola, Bangalore (IN); Rahul Agrawal, Bangalore (IN)

(73) Assignee: Microsoft Corporation, Redmond, WA (US)

(21) Appl. No.: 13/241,345

(22) Filed: Sep. 23, 2011

(51) Int. Cl. G06Q 30/00; G06F 17/30

(52) U.S. Cl. 705/14.46; 705/14.49; 707/722; 707/E17.005

(57) ABSTRACT

Various embodiments pertain to efficiently balancing user experience with advertiser budget and potential publisher revenue in view of considerations that include a number of sponsored or paid results displayed above non-paid search results, a number of sponsored results displayed to the side of non-paid search results, and a defined micromarket for one or more search keywords. In at least some embodiments, a return on investment in the micromarket is also considered. In some embodiments, an explore/exploit technique is utilized to control impact while investigating potential additional micromarkets for an advertiser.

### BACKGROUND

Many search engine web pages include paid or sponsored results that function as advertisements on the search engine results page. These sponsored results can be a major source of revenue for the search engine. Typically, the search engine matches sponsored results to a given user query and displays the sponsored results along with other search results on the search engine results page. The sponsored results commonly appear above the non-paid search results, or organic search results, as well as down the right-hand side of the search results page.

The number of sponsored results can impact the user experience. For example, displaying a large number of sponsored results above non-paid search results can force a user to scroll down the page to access the non-paid search results, which can result in user frustration that can sometimes lead a user to use a competing search engine. Because publishers are commonly paid on a per-click basis, the number and location of sponsored results can also affect publisher revenue and advertiser budgets. Therefore, the number and placement of sponsored results frequently forces publishers to choose between increased revenue or an improved user experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments pertain to efficiently balancing user experience with advertiser budget and potential publisher revenue in view of considerations that include a number of sponsored or paid results displayed above non-paid search results, a number of sponsored results displayed to the side of non-paid search results, and a defined micromarket for one or more search keywords. In at least some embodiments, a return on investment in the micromarket is also considered. In some embodiments, an explore/exploit technique is utilized to control impact while investigating potential additional micromarkets for an advertiser.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 is an illustration of an example environment in accordance with one or more embodiments;

FIG. 2 illustrates an example search engine results page in accordance with one or more embodiments;

FIG. 3 illustrates an example process in accordance with one or more embodiments;

FIG. 4 is an illustration of an example search engine in accordance with one or more embodiments;

FIG. 5 illustrates an example process in accordance with one or more embodiments; and

FIG. 6 illustrates an example system that can be utilized to implement one or more embodiments.

### DETAILED DESCRIPTION

Overview

Many search engines return one or more sponsored search results or advertisements along with one or more non-paid or organic search results in response to a user query. Sponsored search results can be displayed above and/or to the side of the non-paid search results. Because sponsored search results displayed to the side of non-paid search results generally receive fewer clicks from users than sponsored search results displayed above non-paid search results, search engine publishers can generate more revenue by selling more slots to display sponsored search results above the non-paid search results. However, because sponsored search results displayed above non-paid search results down in the list, users need to scroll down the page to access the non-paid search results, which can result in user frustration that can sometimes lead a user to use a competing search engine.

Various embodiments pertain to efficiently balancing user experience with advertiser budget and potential publisher revenue in view of considerations that include a number of sponsored results displayed above non-paid search results, a number of sponsored results displayed to the side of non-paid search results, and a defined micromarket for one or more search keywords. In at least some embodiments, a return on investment in the micromarket is also considered. In some embodiments, an explore/exploit technique is utilized to control impact on revenue while investigating potential different or additional micromarkets for an advertiser. Explore/exploit techniques can also be utilized to control impact on revenue while investigating an impact of varying a number of paid search results displayed.

In the discussion that follows, a section entitled “Example Operating Environment” describes an operating environment in accordance with one or more embodiments. Next, a section entitled “Example Embodiment” describes various embodiments of efficient ad placement, balancing user experience with advertiser budget and potential publisher revenue. Finally, a section entitled “Example System” is provided and describes an example system that can be used to implement one or more embodiments.

Consider, now, an example operating environment in accordance with one or more embodiments.

Example Operating Environment

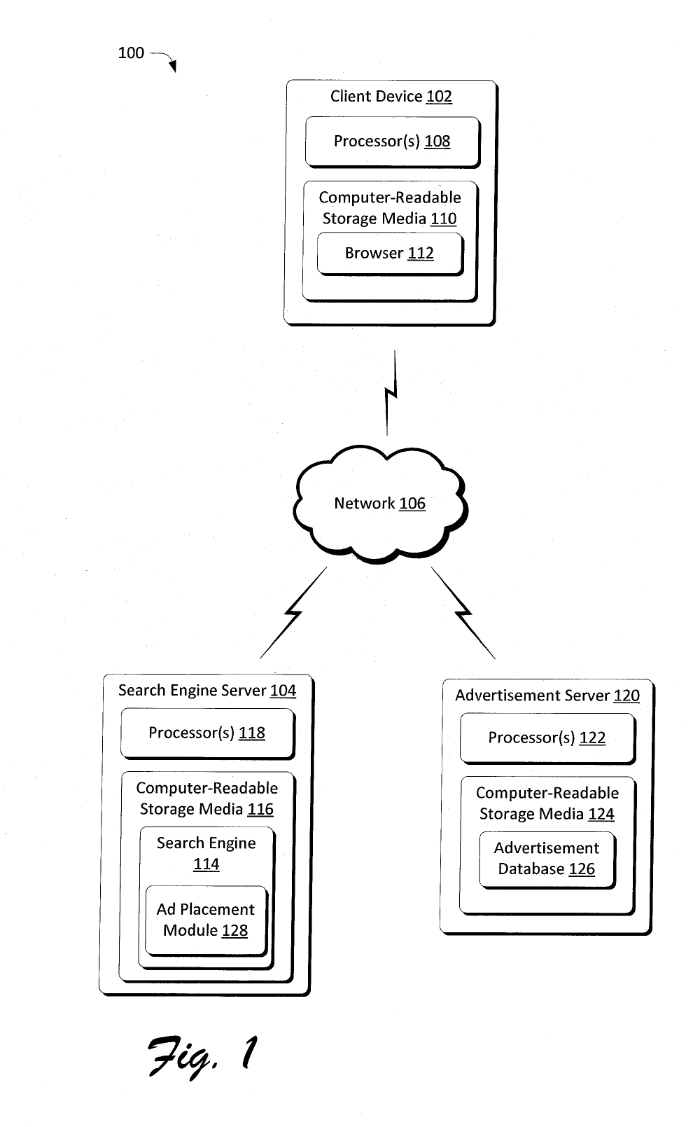

FIG. 1 is an illustration of an example environment 100 in accordance with one or more embodiments. Environment 100 includes a client device 102 communicatively coupled to a search engine server 104 through network 106.

Client device 102 can include one or more processors 108 and computer-readable storage media 110. Client device 102 can be embodied as any suitable computing device such as, by way of example and not limitation, a desktop computer, a portable computer, a netbook, a handheld computer such as a personal digital assistant (PDA), a cell phone, and the like.

Computer-readable storage media 110 includes one or more software applications, which can include a software executable module in the form of a web browser 112. Browser 112 can receive content from and send content to other servers, such as search engine server 104, via network 106, such as the Internet. Such content can include any suitable type of content that can be received from and sent to websites hosted by servers. In various embodiments, browser 112 is configured to send a user query to a search engine and cause a search engine results page (SERP) received from the search engine server, e.g., search engine 114 be displayed to a user.

Search engine 114 resides on computer-readable storage media 116 of search engine server 104. In addition to computer-readable storage media 116, search engine server 104 also includes one or more processors 118 configured to execute the software modules, e.g., search engine 114, residing on computer-readable storage media 116. In various embodiments, search engine 114 receives and processes a user query and returns a listing of web results corresponding to the query. The listing of web results can be presented, for example, as a listing of hyperlinks that, when a user selects one of the hyperlinks, redirects the user's browser to the resultant web page, which can be hosted on an additional server connected to the network 106.

In addition to a listing of web results corresponding to the query, the search engine 114 can also return one or more advertisements to be displayed as part of the SERP. The advertisements can be displayed, for example, above the listing of web results in an area sometimes referred to as a mainline, or to the side of the web results in an area sometimes referred to as a sidebar, and can be selected to correspond to the user query processed by the search engine 114. The advertisements are sometimes referred to as sponsored search results, while the non-paid web results are sometimes referred to as organic search results.

Non-paid results can be selected by the search engine using any suitable technique. For example, a search engine can use automated search technology that selects and ranks web pages based on output from complex, mathematical search algorithms. The search algorithms can search databases using various criteria, such as keyword density and keyword location. Other search engines can use information manually input by staff members charged with reviewing web page information. Other techniques can also be employed.

Advertisements or sponsored search results can be provided to the search engine server 104 by one or more advertisement servers 120. Advertisement server 120 can include one or more processors 122 and one or more computer-readable storage media 124, on which advertisement database 126 resides. Advertisement database 126 stores one or more advertisements provided by one or more advertisers and can transmit the advertisements through network 106 to the search engine server 104 for inclusion in the SERP. Each advertisement can be stored with one or more keywords and/or a bid for each keyword. When an advertisement or sponsored search result stored in the database is presented to a user and is selected by the user, the advertiser pays the amount of the bid to the search engine publisher.

The sponsored search results are selected and assigned a slot on the SERP by ad placement module 128 on search engine server 104. In addition to assigning sponsored search results to available sponsored search result slots on the SERP, ad placement module 128 can determine a total number of sponsored search result slots on the SERP, manage advertiser bids for sponsored search results, determine a micromarket applicable to a user query, and identify a set of sponsored search results related to the micromarket.

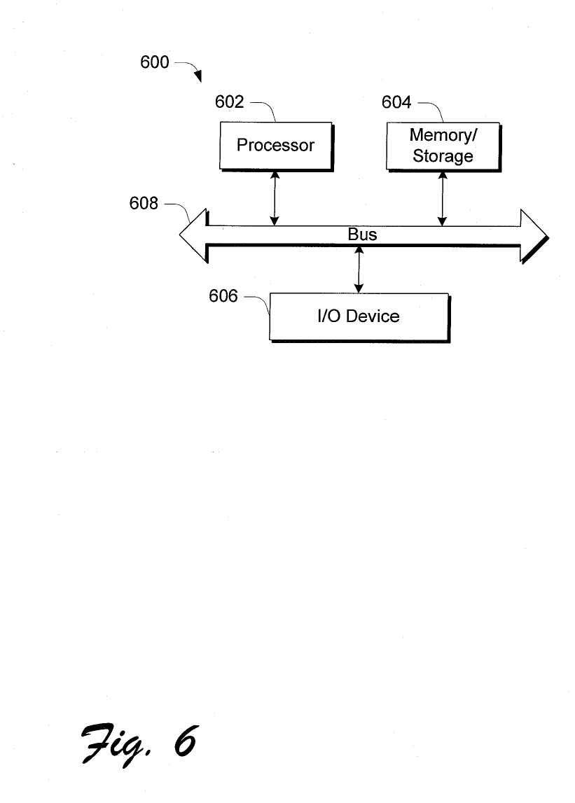

The computer-readable storage media included in each device or server can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 6.

Generally, any of the functions described herein can be implemented using software, firmware, hardware (e.g., fixed logic circuitry) or a combination of these implementations. The terms “module,” “functionality,” and “logic” as used herein generally represent software, firmware, hardware, or a combination thereof. In the case of a software implementation, the module, functionality, or logic represent program code that performs specified tasks when executed on a processor (e.g., CPU or CPUs). The program code can be stored in one or more computer-readable memory devices. The features of the user interface techniques described below are platform-independent, meaning that the techniques may be implemented on a variety of commercial computing platforms having a variety of processors.

Having described an example environment, consider now a discussion of displaying advertisements on SERPs while efficiently balancing user experience with advertiser budget and potential publisher revenue.

### Example Embodiment

The discussion that follows starts first with a description of an example SERP as displayed by a web browser. Following this, a discussion of various embodiments of displaying advertisements on SERPs while efficiently balancing user experience with advertiser budget and potential publisher revenue in view of various user and publisher considerations is provided. The considerations can include a number of sponsored results displayed above non-paid search results, a number of sponsored results displayed to the side of non-paid search results, and a defined micromarket for one or more search keywords.

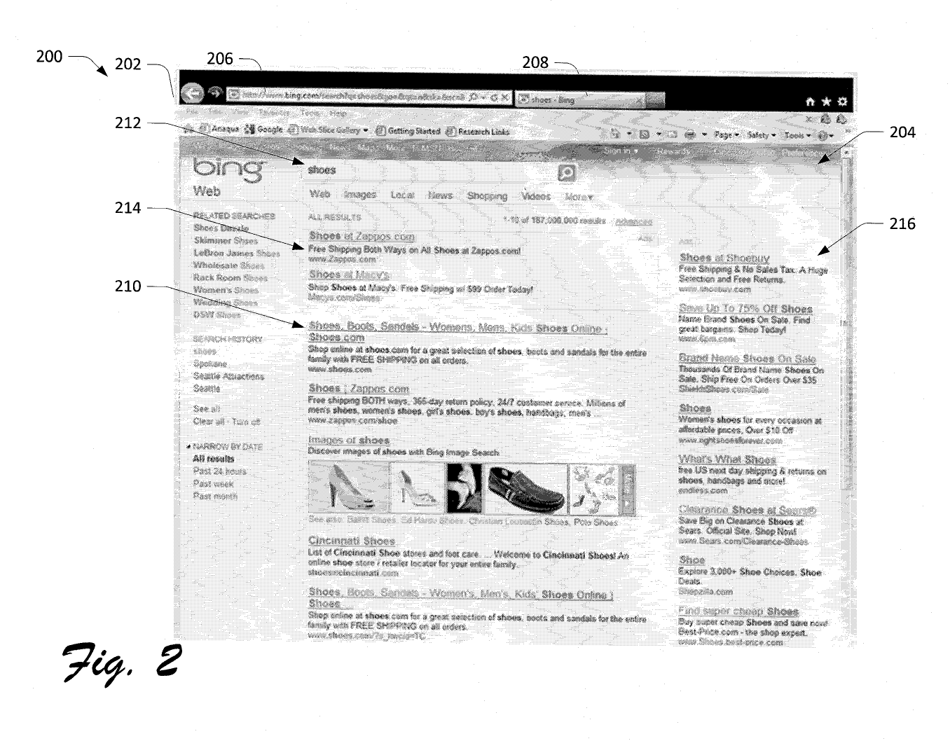

FIG. 2 is an illustration of an example SERP 200 in accordance with various embodiments. In this particular example, SERP 200 is displayed within a web browser user interface 202 which includes a content rendering area 204, an address bar 206, and one or more tabs 208. Other controls can be provided depending on the specific embodiment.

Content rendering area 204 can display a SERP or other web page to a user. In the example shown in FIG. 2, SERP can include one or more organic search results 210 that correspond to a user query, such as the query shown in query box 212. SERP 200 can also display one or more sponsored search results in addition to the organic search results 210. Sponsored search results can be displayed in an area above the organic search results (e.g., sponsored search results 214) or along the side of the organic search results (e.g., sponsored search results 216). Sponsored search results can also be displayed below or to the left of organic search results, depending on the specific embodiment.

In various embodiments, when a user clicks on a sponsored search result, the advertiser, or sponsor of that search result, pays a particular price to the search engine publisher. In other words, advertisers pay per user click, and the price each advertiser pays per click can vary. For example, advertisers can bid an amount per click they would pay for a particular keyword appearing in or derived from user queries. In such embodiments, when a user enters the keyword into the query box, some or all of the advertisers who have bid on that keyword are awarded advertising slots, and their sponsored search results are displayed in the SERP. Then, when user clicks on one of the sponsored search results, the search engine publisher charges the advertiser the amount of the bid.

In various embodiments, the number of sponsored search results 214 displayed above the organic search results and the number of sponsored search results 216 displayed to the side of the organic search results can vary. Techniques described below can be used to determine a number of sponsored search results 214 and 216 based on a defined micromarket for one or more search keywords to efficiently balance user experience with advertiser budget and potential publisher revenue. For example, as shown in FIG. 2, a SERP responding to a user query for “shoes” includes two sponsored search results 214 above the organic search results 210 and eight or more sponsored search results 216 next to the organic search results 210. However, the techniques described below can ascertain whether the number of sponsored search results displayed above the organic search results should be increased for a user query for “baseball.” In some embodiments, the techniques described below can be used to determine a number of slots for sponsored search results 214 and 216. One or more slots can be unoccupied, such as when there are an insufficient number of sponsored search results or a reserve for the slots.

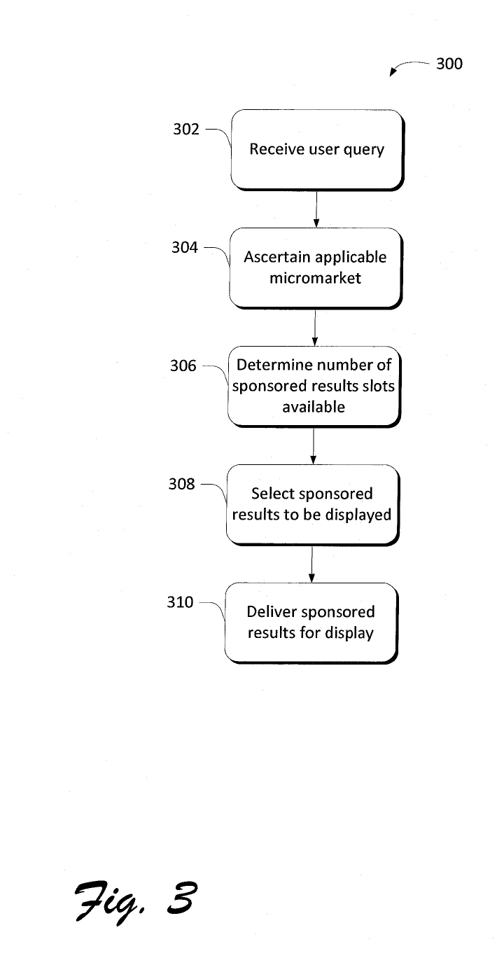

In FIG. 3, an example process 300 for delivering sponsored search results in response to a user query in accordance with one or more embodiments is shown. The method can be implemented in connection with any suitable hardware, software, firmware, or combination thereof. In at least some embodiments, the method can be implemented in software.

Block 302 receives a user query. This can be done in any suitable way. For example, a search engine server can receive a user-entered query through a network connection, such as the Internet.

Block 304 ascertains an applicable micromarket, sometimes called a niche or category, for the user query. This can be done in any suitable way. For example, the search engine server can extract keywords from the user query and determine a micromarket associated with those keywords. Micromarkets can vary in size, and can include one or more other micromarkets. For example, one micromarket “cars” can include other micromarkets such as “new cars,” “used cars,” and “car insurance.” The techniques described above and below can be used to determine criteria for displaying advertisements on SERPs while efficiently balancing user experience with advertiser budget and potential publisher revenue in micromarkets of varying sizes, including on a global level.

Block 306 determines a number of sponsored result slots available. This can be done in any suitable way. Various factors can be considered when determining a number of sponsored search results to display on a SERP. For example, a user experience cost (UEC) can be taken into consideration. The UEC is a measurement of a number of irrelevant sponsored results that are presented to a user. A high number of irrelevant search results presented to a user can harm the user's experience, and in some cases, can drive the user to a competitor's search engine. In one or more embodiments, the UEC can be represented according to a mathematical expression

$$UEC ( u ) = \frac{1}{{SERP}_{u}} {\sum }_{SERP}^{ } {\sum }_{ad ∈ SERP}^{ } exp ( - \frac{{rel}_{ad}}{σ} ) * 1$$

where SERPᵤ is a number of search engine result pages displayed to a user, rel_{ad} is the relevance of an ad to the user, and σ is a control parameter. The relevance of an ad to a user can be determined, for example, by the number of clicks or a probability that a user will click on the ad. Control parameter σ can vary depending on the particular embodiment. For example, in various embodiments, the control parameter σ is set to one-fourth of the click-through rate (CTR). In other words,

$$σ = \frac{CTR}{4}$$

where CTR is the number of clicks on an ad divided by the number of times the ad is shown. In such embodiments, ads in the lowest 25% in terms of CTR are considered irrelevant. The control parameter can be varied to include a greater or lesser percentage of CTR ads as relevant, or can be based on a variable other than CTR.

In various embodiments, the search engine server determines a threshold number of sponsored search results to be displayed above organic results so that a UEC remains below or equal to a defined UEC Budget. The UEC Budget, or maximum user cost that can be utilized to serve ads above organic results for a given market, can, in one or more embodiments, be determined according to an expression

$$UECBudget \geq \frac{1}{SERP} {\sum }_{SERP}^{ } {\sum }_{ad ∈ SERP}^{ } exp ( - \frac{{rel}_{ad}}{σ} ) * 1$$

where SERP is a number of search engine result pages in a set, rel_{ad} is the relevance of an ad to the user, and σ is a control parameter. The particular value selected as the UEC Budget can vary depending on the embodiment, and can be selected using business principles. For example, a UEC Budget for a market with a low return on investment (ROI) for a sponsored search result, e.g., books or flowers, can be much higher than a UEC Budget for a market with a high ROI, e.g., jewelry or automobiles.

For a given UEC Budget, a number of sponsored search results to be displayed above organic results can, in one or more embodiments, be selected according to an expression

$${T}^{*} = arg {max}_{T} Revenue$$

$$subject to \frac{1}{SERP} {\sum }_{SERP}^{ } {\sum }_{ad ∈ SERP}^{ } exp ( - \frac{{rel}_{ad}}{σ} ) * 1 \leq UECBudget$$

where T* is a threshold number of sponsored search results to be displayed above organic search results, or the number of sponsored result slots available, that results in a maximum revenue, SERP is a number of search engine result pages in a set, rel_{ad} is the relevance of an ad to the user, and σ is a control parameter.

Once the number of sponsored result slots available is determined, block 308 selects the sponsored results to be displayed. This can be done in any suitable way. For example, the search engine server can select the top three revenue generators associated with a keyword, top bidders, or the like. An amount of expected revenue can be estimated based on how much revenue has been received when the sponsored search result was previously displayed or the past amount of revenue generated by the sponsored search result. The number of sponsored results to be displayed can be less than or equal to the number of sponsored result slots available. As another example, sponsored results can be selected according to an assigned rank. The search engine server or another entity can assign each sponsored result a ranking based on information such as a click-through rate, a bid, or an amount of advertiser budget available.

Block 310 delivers the sponsored search results for display as part of the SERP. This can be done in any suitable way. For example, the search engine server can transmit the sponsored search results with or separate from the organic search results to be displayed.

Having described a general process for delivering sponsored search results in response to a user query, consider now an example search engine that can be used to implement one or more embodiments.

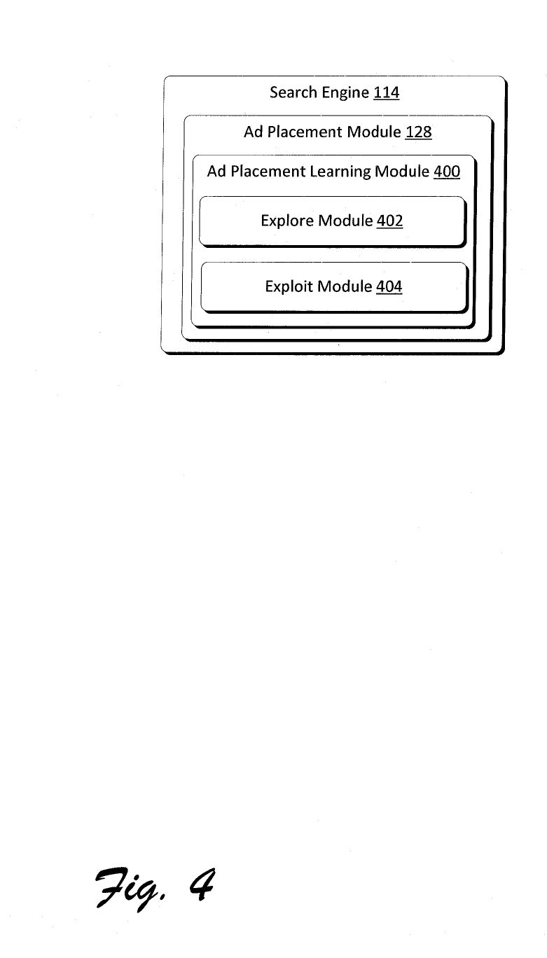

FIG. 4 depicts an example search engine 114 including ad placement module 128 in accordance with one or more embodiments. Ad placement module 128 can also include an ad placement learning module 400. Ad placement learning module 400 can be used to determine the number of sponsored result slots available and determine a rate of tradeoff between revenue and a UEC Budget for various micromarkets. Additionally, ad placement learning module 400 can be used to test new or underutilized micromarkets for a given sponsored search result or advertiser while satisfying global constraints.

As shown in FIG. 4, ad placement learning module 400 includes an explore module 402 and an exploit module 404. Explore module 402 and exploit module 404 enable ad placement learning module 400 to explore new or underutilized micromarkets (through explore module processes) while exploiting micromarkets that are known to produce revenue using a given sponsored search result and satisfy one or more global constraints (through exploit module processes). Global constraints can include, by way of example and not limitation, a percentage of user queries to be covered by the advertisement (sometimes called coverage), a total amount of money to be spent by an advertiser, a minimum amount of revenue generated by a search engine, and the like. Explore module 402 and exploit module 404 can also enable ad placement learning module 400 to evaluate and adjust a UEC Budget for a given micromarket by implementing an explore/exploit strategy based on a variable number of sponsored search results to be displayed above organic search results, or the number of sponsored result slots available, that result in a maximum revenue (T*).

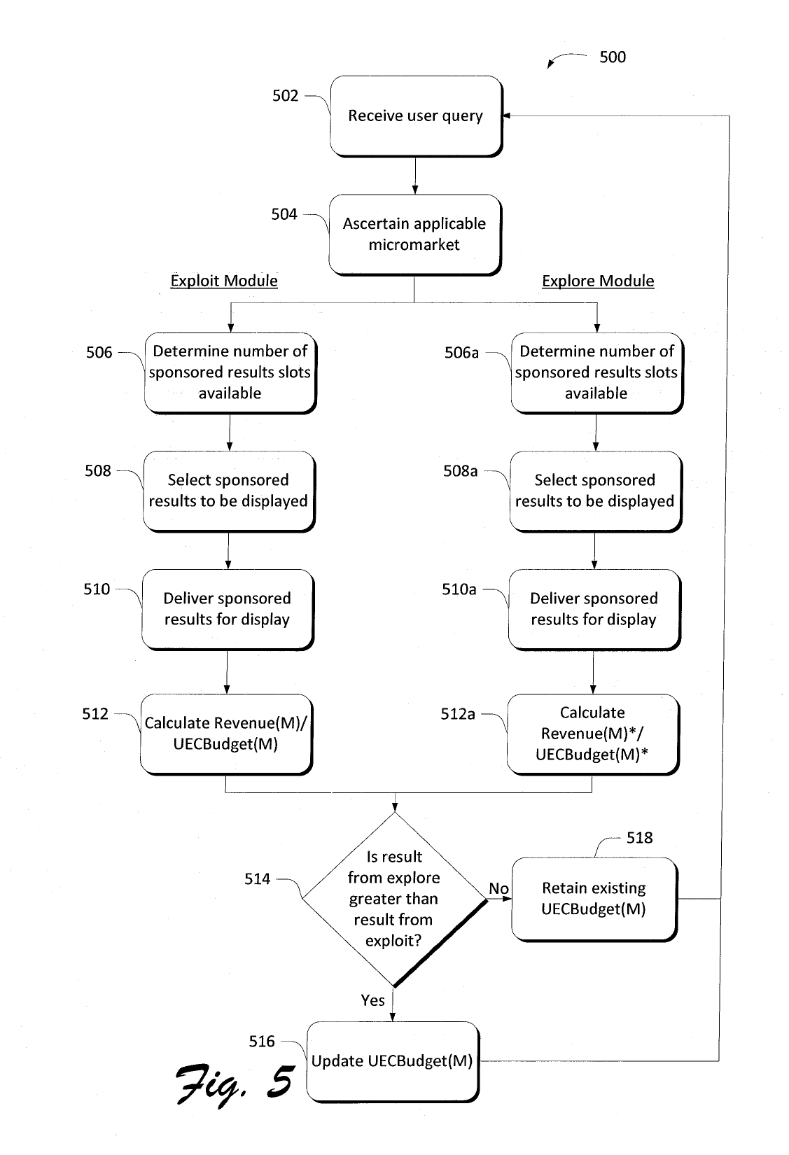

FIG. 5 depicts an example method 500 of using an explore/exploit strategy to evaluate and adjust a UEC Budget. The method can be implemented in connection with any suitable hardware, software, firmware, or combination thereof. In at least some embodiments, the method can be implemented in software. In the illustrated example, some steps of the method are illustrated as being performed by an “Explore Module” while other steps of the method are illustrated as being performed by an “Exploit Module.” It is to be appreciated and understood that the steps that are illustrated as being performed by these entities can be performed by any suitable service or entity.

Block 502 receives a user query. This can be done in any suitable way. For example, a search engine server can receive a user query through a network connection, such as the Internet.

Block 504 ascertains an applicable micromarket for the user query. This can be done in any suitable way. For example, the search engine server can extract keywords from the user query and determine a micromarket associated with those keywords.

At block 506, the exploit module determines a number of sponsored result slots available based on an existing UEC Budget for the micromarket (UECBudget(M)). This can be done in any suitable way, examples of which are provided above.

At block 506a, the explore module determines a number of sponsored result slots available based on an adjusted UEC Budget for the micromarket (UECBudget(M)*). This can be done in any suitable way. For example, the adjusted UEC Budget can be represented as an expression

UECBudget(M)*=UECBudget(M)+δ

where UECBudget(M) is the existing UEC Budget used by the exploit module in block 506 and δ is an adjustment factor selected according to publisher constraints. For example, δ can be selected such that the expected revenue is a minimum amount.

At blocks 508 and 508a, the exploit and explore modules select sponsored results to be displayed, respectively. This can be done in any suitable way. Next, the exploit and explore modules deliver sponsored results for display at blocks 510 and 510a, respectively. This can be done in any suitable way.

At block 512, after the SERP has been displayed in response to the user query, the exploit module calculates the revenue generated and calculates a ratio of revenue to UEC Budget (Revenue(M)/UECBudget(M)). This can be done in any suitable way. Similarly, at block 512a, the explore module calculates the revenue generated and calculates a ratio of revenue to the adjusted UEC Budget (Revenue(M)*/UECBudget(M)*). This can be done in any suitable way.

Next, block 514 determines if the result from the explore module is greater than the result from the exploit module. If the answer is yes, e.g., Revenue(M)*/UECBudget(M)* is greater than Revenue(M)/UECBudget(M), block 516 updates the UEC Budget. After the UEC Budget is updated, the process can return to block 502 and receive another user query for further exploration. If the answer at block 514 is no, e.g., Revenue(M)*/UECBudget(M)* is less than Revenue(M)/UECBudget(M), block 518 retains the existing UEC Budget (UECBudget(M)), and the process can return to block 502. In various embodiments, blocks 512/512a, 514, 516, and 518 can be an offline process while the rest of method 500 occurs during ad placement module runtime.

The explore/exploit technique described in FIG. 5 can additionally be used to evaluate and adjust a UEC Budget across various micromarkets to extrapolate from micromarkets to a global level, or vice versa. For example, these techniques can enable a publisher to explore placing a particular sponsored search result in a different micromarket while maintaining a certain level of revenue from the advertiser. Additionally, when identifying a new micromarket, these techniques can enable a publisher to explore the nuances of that particular micromarket while maintaining a given revenue stream in related micromarkets. For example, a publisher can use these techniques to define constraints for a “car insurance” micromarket within a “cars” micromarket by using the constraints in place for the “cars” micromarket as a starting point.

Having described various embodiments of displaying advertisements on SERPs while efficiently balancing user experience with advertiser budget and potential publisher revenue, consider now an example system that can be used to implement one or more embodiments.

Example System

FIG. 6 illustrates an example computing device 600 that can be used to implement the various embodiments described above. Computing device 600 can be, for example, client device 102 or search engine server 104 of FIG. 1 or any other suitable computing device.

Computing device 600 includes one or more processors or processing units 602, one or more memory and/or storage components 604, one or more input/output (I/O) devices 606, and a bus 608 that allows the various components and devices to communicate with one another. Bus 608 represents one or more of any of several types of bus structures, including a memory bus or memory controller, a peripheral bus, an accelerated graphics port, and a processor or local bus using any of a variety of bus architectures. Bus 608 can include wired and/or wireless buses.

Memory/storage component 604 represents one or more computer storage media. Memory/storage component 604 can include volatile media (such as random access memory (RAM)) and/or nonvolatile media (such as read only memory (ROM), flash memory, optical disks, magnetic disks, and so forth). Memory/storage component 604 can include fixed media (e.g., RAM, ROM, a fixed hard drive, etc.) as well as removable media (e.g., a flash memory drive, a removable hard drive, an optical disk, and so forth).

One or more input/output devices 606 allow a user to enter commands and information to computing device 600, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A computer-implemented method comprising:
receiving a user query comprising one or more keywords;
ascertaining an applicable micromarket based at least on the one or more keywords;
determining a number of sponsored result slots available based on the applicable micromarket;
selecting sponsored results to be displayed, the sponsored results to be displayed numbering less than or equal to the number of sponsored result slots available; and
delivering the sponsored results to be displayed.

2. The computer-implemented method of claim 1, wherein said determining comprises determining a number of sponsored result slots available above a number of organic search results on a search engine results page.

3. The computer-implemented method of claim 1, wherein said determining comprises determining a number of sponsored result slots available above a number of organic search results on a search engine results page and to a side of the number of organic search results on the search engine results page.

4. The computer-implemented method of claim 1, wherein said determining comprises determining a number of sponsored results available according to an expression
$${T}^{*} = arg {max}_{T} Revenue$$
$$subject to \frac{1}{SERP} {\sum }_{SERP}^{ } {\sum }_{ad ∈ SERP}^{ } exp ( - \frac{{rel}_{ad}}{σ} ) * 1 \leq UECBudget$$
where T* is a number of sponsored result slots available that results in a maximum revenue, SERP is a number of search engine result pages in a set, rel_{ad} is a relevance of an ad to a user, σ is a control parameter, and UECBudget is a user experience cost budget.

5. The computer-implemented method of claim 4, wherein the user experience cost budget depends on the applicable micromarket.

6. The computer-implemented method of claim 4, wherein σ is set to one-fourth of a click-through rate.

7. The computer-implemented method of claim 1, wherein said selecting comprises selecting sponsored results from one or more top revenue generators.

8. A device comprising:
one or more processors;
one or more computer-readable storage media;
one or more modules embodied on the one or more computer-readable storage media and executable under the influence of the one or more processors, the one or more modules comprising:
a search engine configured to receive and process a user query and return a listing of web results corresponding to the user query to be displayed on a search engine results page; and
an ad placement module configured to:
ascertain a micromarket applicable to the user query,
determine a number of sponsored search result slots on the search engine results page,
identify a set of sponsored search results related to the micromarket, and
select one or more sponsored search results to be displayed on the search engine results page from the set of sponsored search results related to the micromarket.

9. The device of claim 8, wherein the ad placement module is configured to determine a number of sponsored search result slots on the search engine results page according to an expression
$${T}^{*} = arg {max}_{T} Revenue$$
$$subject to \frac{1}{SERP} {\sum }_{SERP}^{ } {\sum }_{ad ∈ SERP}^{ } exp ( - \frac{{rel}_{ad}}{σ} ) * 1 \leq UECBudget$$
where T* is a number of sponsored result slots available that results in a maximum revenue, SERP is a number of search engine result pages in a set, rel_{ad} is a relevance of an ad to a user, σ is a control parameter, and UECBudget is a user experience cost budget.

10. The device of claim 9, wherein the user experience cost budget depends on the micromarket applicable to the user query.

11. The device of claim 8, the one or more modules further comprising:
an explore module configured to determine a first number of sponsored result slots on the search engine results page, select one or more sponsored results to be displayed on the search engine results page, and calculate a ratio of revenue to adjusted user experience cost budget; and
an exploit module configured to determine a second number of sponsored result slots on the search engine results page, select one or more sponsored results to be displayed on the search engine results page, and calculate a ratio of revenue to user experience cost budget.

12. The device of claim 11, wherein at least one of the one or more modules is configured to compare the ratio of revenue to adjusted user experience cost budget with the ratio of revenue to user experience cost budget and to update the user experience cost budget when the ratio of revenue to adjusted user experience cost budget is greater than the ratio of revenue to user experience cost budget.

13. The device of claim 11, wherein the first number of sponsored search result slots on the search engine results page is determined according to an expression
$${T}^{{*}^{′}} = arg {max}_{T} Revenue$$
$$subject to \frac{1}{SERP} {\sum }_{SERP}^{ } {\sum }_{ad ∈ SERP}^{ } exp ( - \frac{{rel}_{ad}}{σ} ) * 1 \leq {UECBudget ( M )}^{*}$$
where T*′ is the first number of sponsored result slots resulting in a maximum revenue, SERP is a number of search engine result pages in a set, rel_{ad} is a relevance of an ad to a user, σ is a control parameter, and UECBudget(M)* is the adjusted user experience cost budget for the micromarket; and
wherein the second number of sponsored search result slots on the search engine results page is determined according to an expression
$${T}^{*} = arg {max}_{T} Revenue$$
$$subject to \frac{1}{SERP} {\sum }_{SERP}^{ } {\sum }_{ad ∈ SERP}^{ } exp ( - \frac{{rel}_{ad}}{σ} ) * 1 \leq UECBudget ( M )$$
where T* is the second number of sponsored result slots resulting in a maximum revenue, SERP is a number of search engine result pages in a set, rel_{ad} is a relevance of an ad to a user, σ is a control parameter, and UECBudget is the user experience cost budget for the micromarket.

14. The device of claim 13, wherein σ is set to one-fourth of a click-through rate.

15. One or more computer-readable storage media comprising instructions that are executable to cause a device to perform a process comprising:
ascertaining an applicable micromarket depending on one or more keywords in a user query;
determining a number of sponsored result slots available based on the applicable micromarket;
selecting sponsored results to be displayed above a listing of web results corresponding to the user query to be displayed on a search engine results page, the sponsored results to be displayed above a listing of web results corresponding to the user query numbering less than or equal to the number of sponsored result slots available.

16. The one or more computer-readable storage media of claim 15, the process further comprising:
receiving the user query, the user query comprising the one or more keywords; and
delivering to a user device the sponsored results to be displayed.

17. The one or more computer-readable storage media of claim 15, the process further comprising:
selecting sponsored results to be displayed to a side of the listing of web results corresponding to the user query.

18. The one or more computer-readable storage media of claim 15, said selecting comprising selecting one or more sponsored results according to an assigned rank for each one or more sponsored result.

19. The one or more computer-readable storage media of claim 18, wherein the assigned rank is based at least in part on at least one of a click-through rate, a bid, and an amount of advertiser budget available.

20. The one or more computer-readable storage media of claim 18, wherein the assigned rank is based at least in part on a past amount of revenue generated by each one or more sponsored result.
